(19) United States
(12) Patent Application Publication
(10) Pub. No.: US 2026/0371147 A1
(43) Pub. Date: Nov. 19, 2026

(54) SYSTEMS AND METHODS ASSOCIATED WITH REDUNDANT STEERING MODE AND SUSPENSION OF TRAFFIC DUPLICATION

(71) Applicant: InterDigital Patent Holdings, Inc., Wilmington, DE (US)

(72) Inventors: Rocco Di Girolamo, Laval (CA); Xavier De Foy, Kirkland (CA); Michelle Perras, Montreal (QC); Guanzhou Wang, Brossard (CA); Saad Ahmad, Montreal (CA)

(73) Assignee: InterDigital Patent Holdings, Inc., Wilmington, DE (US)

(21) Appl. No.: 19/470,756

(22) PCT Filed: Apr. 5, 2024
(86) PCT No.: PCT/US2024/023417

§ 371 Date: Sep. 29, 2025

Related U.S. Application Data
(60) Provisional application No. 63/457,667, filed on Apr. 6, 2023.

(51) Int. Cl. H04W 28/02

(52) U.S. Cl. CPC H04W 28/0231

(57) ABSTRACT

Disclosed herein are systems, methods and instrumentalities associated with the suspension of traffic duplication. A wireless transmit/receive unit (WTRU) may receive, from a first network node, configuration information regarding suspension of traffic duplication. The WTRU may further receive a request message from a second network node, wherein the request message may indicate a request to suspend traffic duplication. The WTRU may determine, based on the configuration information received from the first network node, the request message received from the second network node, and a condition at the WTRU, to suspend duplicating traffic, at least partially, in a first access leg of the WTRU. The WTRU may send a response message to the second network node, wherein the response message may indicate that traffic duplication is suspended (e.g., at least partially) in the first access leg.

### CROSS-REFERENCE TO RELATED APPLICATIONS

This application claims the benefit of Provisional U.S. Patent Application No. 63/457,667, filed Apr. 6, 2023, the disclosure of which is incorporated herein by reference in its entirety.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Disclosed herein are systems, methods and instrumentalities associated with the suspension of traffic duplication. A wireless transmit/receive unit (WTRU) as described herein may receive, from a first network node, configuration information regarding suspension of traffic duplication. The WTRU may further receive a request message from a second network node, wherein the request message may indicate a request to suspend traffic duplication. The WTRU may determine, based on the configuration information received from the first network node, the request message received from the second network node, and a condition at the WTRU, to suspend duplicating traffic, at least partially, in a first access leg of the WTRU. The WTRU may send a response message to the second network node, wherein the response message may indicate that traffic duplication is suspended (e.g., at least partially) in the first access leg.

In examples, the conditions at the WTRU may be associated with at least one of a power consumption of the WTRU, a frequency used by the WTRU, a connection type associated with the first access leg or a second access leg, or a performance metric associated with the first access leg or the second access leg. In examples, the response message sent to the second network node may further indicate a duration or a periodicity of the suspension of traffic duplication in the first access leg. In examples, the response message sent to the second network node may further indicate that the WTRU may use a second access leg for transmission or reception of traffic (e.g., data and/or control information) while traffic duplication in the first access leg is suspended.

In examples, the WTRU may enter a power saving mode (e.g., with respect to the suspended access leg) in response to receiving the request message from the second network node. In examples, the request message received from the second network node may indicate a duration or a periodicity of the suspension of traffic duplication, an access leg to be used during the suspension of traffic duplication, or a steering mode to be used during the suspension of traffic duplication. In examples, the request message received from the second network node may indicate one or more service data flows (SDFs) exempted from the suspension of traffic duplication, in which case the WTRU may continue to duplicate traffic associated with the one or more exempted SDFs in the first access leg.

In examples, the first access leg described herein may be associated with one of a cellular communication network or a non-cellular communication network, and, while traffic duplication is suspended in the first access leg, the WTRU may perform transmission or reception of traffic (e.g., data and/or control information) in a second access leg that may be associated with the other one of the cellular communication network or the non-cellular communication network. In examples, the suspension of traffic duplication may be associated with a multiple-access protocol data unit session. In examples, the configuration information may be received as part of access traffic steering, switching and splitting (ATSSS) rules.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating a WTRU with a 3GPP access and a non-3GPP access.

FIG. 3 is another system diagram illustrating a WTRU with a 3GPP access and a non-3GPP access.

FIG. 4 is a system diagram associated with a redundant steering mode (RSM).

FIG. 5A is a diagram illustrating an example procedure associated with suspending traffic duplication.

FIG. 5B is a diagram illustrating another example procedure associated with suspending traffic duplication based on CDRX configuration information.

FIG. 6 is a diagram illustrating an example of duplicating performance management function PMF signaling.

FIG. 7 is a diagram illustrating an example of activating an access leg due to an event at a WTRU (e.g., the WTRU losing connectivity).

FIG. 8 is a diagram illustrating an example procedure associated with a WTRU changing serving cells on a suspended access leg.

### DETAILED DESCRIPTION

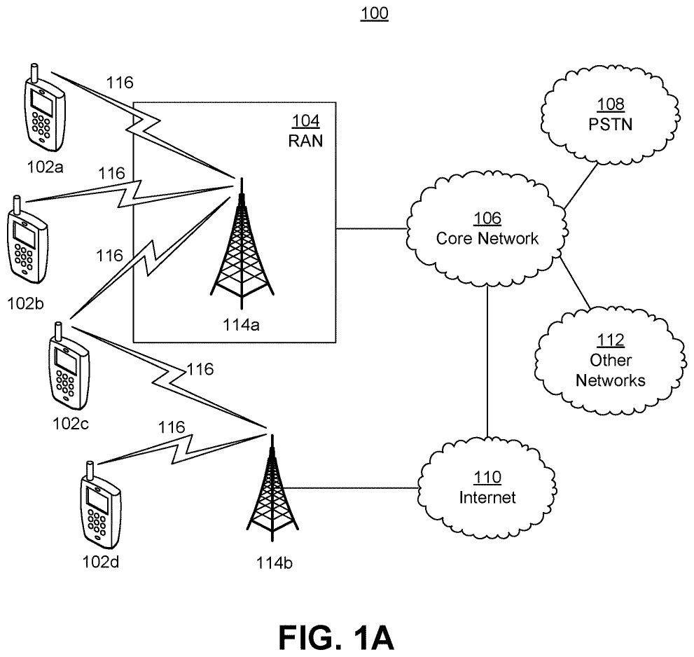

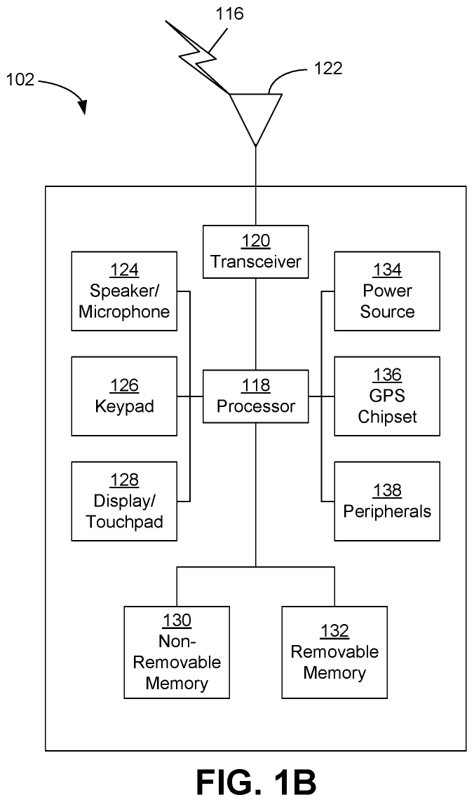

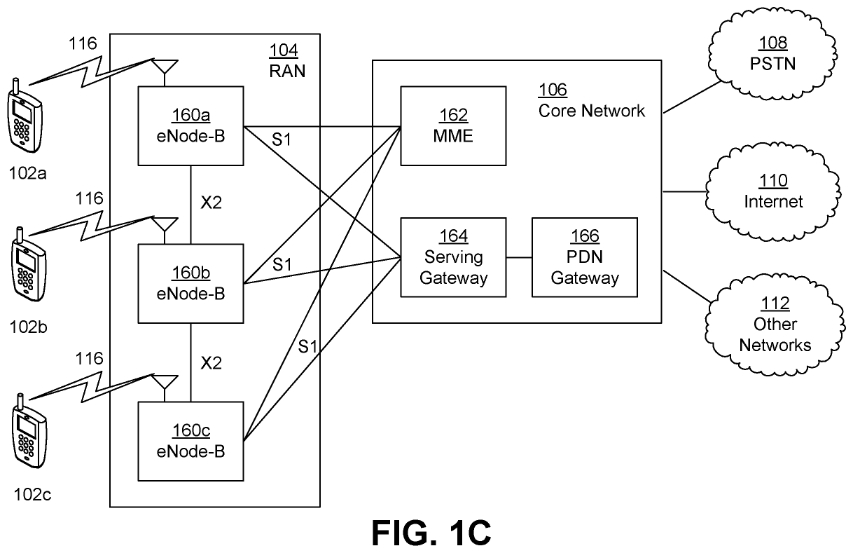

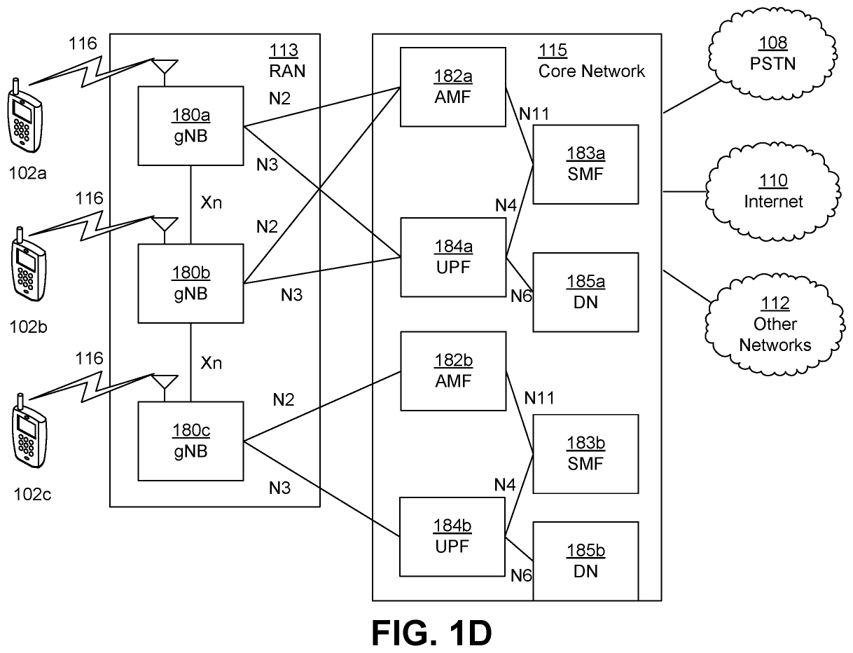

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 1020, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown), These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WIFI), IEEE 802.16 (i.e., Worldwide Interoperability for Microwave Access (WIMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802. 11 to establish a wireless local area network (WLAN). In an embodiment, the base station 114b and the WTRUs 1020, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110.

Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 1020, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WIMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NIMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like, As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 1600 in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, Interworking between NR and E-UTRA, routing of user plane data towards User Plane Function (UPF) 184a, 184b, routing of control plane information towards Access and Mobility Management Function (AMF) 182a, 182b and the like, As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, It will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 1020, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WIFI.

The SMF 183a, 183b may be connected to an AMF 182a, 182b in the CN 115 via an N11 interface. The SMF 183a, 183b may also be connected to a UPF 184a, 184b in the CN 115 via an N4 interface, The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to a time, a time period, a tracking of time, a tracking of a period of time, a combination thereof, and/or the like. Reference to a timer expiration herein may refer to determining that the time has occurred or that the period of time has expired.

The following abbreviations and acronyms may be used herein:
AN Access Node
AMF Access and Mobility management Function
ATSSS Access Traffic Steering, Switching and Splitting
ATSSS-LL ATSSS Low-Layer
CDRX Connected Mode Discontinuous Reception
CE Control Element
DCI Downlink Control Information
DL Downlink
DN Data Network
EPT Extended procedure transaction identity
GBR Guaranteed Bit Rate
gNB Next Generation Node B
HPLMN Home PLMN
IP Internet Protocol
LTE Long Term Evolution
MAC Media Access Control
MA-PDU Multi-Access PDU
MP-DCCP Multi-Path Datagram Congestion Control Protocol
MPTCP Multi-Path TCP
MP-TCP Multi-Path TCP
NAS Non-Access Stratum
NR New Radio
PCC Policy and Charging Control
PCF Policy Control Function
PDU Protocol Data Unit
PLMN Public Land Mobile Network
PLR Packet Loss Ratio
PMF Performance Management Function
PSA PDU Session Anchor
QoE Quality of Experience
QoS Quality of Service
RAN Radio Access Network
RAT Radio Access Technology
RI Request identity
RF Radio Frequency
RRC Radio Resource Control
RTT Round Trip Time
SDF Service Data Flow
SM Session Management
SMF Session Management Function
TCP Transmission Control Protocol
UDP User Datagram Protocol
UE User Equipment
UL Uplink
UPF User Plane Function
VPLMN Visitor PLMN

A wireless transmit/receive unit (WTRU) may support a Multi-Access Protocol Data Unit (MA PDU) session, MA PDU transmissions, and/or a Redundant Steering Mode (RSM). The WTRU may include a processor. The WTRU may receive a first message from a first network node (e.g., a RAN node or a PCF), wherein the first message may comprise one or more ATSSS rules and/or configuration information. In examples, the one or more ATSSS rules may be provided as part of the configuration information, or vice versa. The configuration information may indicate an access (e.g., an access leg) to be used when traffic duplication is suspended. The WTRU may receive a request message (e.g., a Performance Management Function (PMF) request message) from a second network node (e.g., a UPF). The request message may indicate a request to suspend traffic duplication. The WTRU may determine an access leg associated with the suspension of traffic duplication based on the first message received from the first network node, the request message received from the second network node, and/or a condition associated with the WTRU. The WTRU may send a response message (e.g., a PMF response message) to the second network node. The response message may indicate a request for the WTRU to enter a power save mode (e.g., for the determined access leg).

When referred to herein, suspension of traffic duplication may be associated with specific service data flows (SDFs). For example, when two access legs or access networks are available for transmitting and/or receiving traffic and traffic duplication is enabled, traffic associated with an SDF may be duplicated across the two access legs. Suspension of traffic duplication in such an example may mean transmitting or receiving traffic associated with the SDF on one access leg of the two access legs, while stop duplicating the traffic on the other access leg.

When referred to herein, a PMF message may be a control plane message that may be transmitted or received over a user plane. A PMF message may be carried in a data radio bearer to a RAN node, and/or in a user plane tunnel between the RAN node and a network device such as the UPF.

In an example, the configuration information may indicate at least one of an instruction for operating when traffic duplication is suspended (e.g., at least partially), a duration of a traffic duplication suspension, or a list of SDFs exempted from the suspension of traffic duplication. In an example, the second network node may provide a user plane function (UPF). In an example, the request message may further indicate at least one of a second access (e.g., a second access leg) to be used when traffic duplication is suspended (e.g., at least partially), a duration of a traffic duplication suspension, a time that indicates when traffic duplication is to be suspended, a direction (e.g. uplink or downlink) of a suspension, or a list of SDFs exempted from the suspension of traffic duplication. In an example, the condition used by the WTRU to make decisions associated with the suspension of traffic duplication may include at least one of a power level, an operating frequency, or a link performance.

In an example, a first network node (e.g., a UPF) may support an MA PDU session or transmission, and/or a Redundant Steering Mode (RSM). The first network node may comprise a processor. The first network node may receive a first message from a second network node (e.g., a PCF), wherein the first message may comprise one or more N4 rules and/or configuration information regarding the suspension of traffic duplication. For instance, the configuration information may indicate an access (e.g., an access leg) to be used when traffic duplication is suspended. The first network device (e.g., a UPF) may receive an indication from a third network node (e.g., an Intermediate-UPF (I-UPF) between the RAN node and a PDU session anchor UPF (PSF-UPF), an SMF, or a RAN node) to suspend traffic duplication. The second network node may determine that traffic duplication is suspended based on the received indication, The second network node may send a request message (e.g., a PMF request message) to a WTRU. The request message may indicate a request to suspend traffic duplication and may indicate an access (e.g., an access leg) to use when traffic duplication is suspended. The second network node may receive a response message (e.g., a PMF response message) from the WTRU. The response message may indicate a request by the WTRU to enter a power save mode based on an access leg.

The configuration information described in the example above may further indicate at least one of an instruction for operating when traffic duplication is suspended (e.g., at least partially), a duration of a traffic duplication suspension, or a list of exempt SDFs. The request message (e.g., PMF request message) described in the example above may further indicate at least one of an instruction for operating when traffic duplication is suspended, a duration of a traffic duplication suspension, or a list of exempt SDFs. The second network node (e.g., UPF) described in the example above may determine to suspend downlink duplication over an access leg based on the received response message (e.g., PMF response message). The second network node may send a message to a fourth network node (e.g., a RAN node) to indicate that the access leg has been suspended.

In an example, a WTRU may support an MA PDU session or transmission. The WTRU may comprise a processor. The WTRU may receive configuration information for PMF signaling (e.g., via one or more ATSSS rules). The WTRU may generate a PMF message and send it to a network node (e.g., a UPF). The PMF message may include an indication (e.g., a bit field) that the PMF message is a first (e.g., initial) transmission of the PMF message. The WTRU may determine an access leg to use to send the PMF message and may send the PMF message to the network node using the access leg.

In the example described above, the configuration information may indicate at least one of PMF transmission information for sending a PMF message, or PMF retransmission information for sending retransmissions of a PMF message. The access leg in the example described above may be determined based on a steering mode (e.g., steering mode rules). The WTRU may further determine that the PMF message should be retransmitted, and may modify the PMF message to indicate that the PMF message is a retransmission. In some scenarios, the WTRU may use a first access leg for the first (e.g., initial) transmission of the PMF message and use a second access leg for the retransmission of the PMF message. The second access leg may be determined based on a steering mode (e.g., steering mode rules). In some scenarios, the WTRU may send a message to a network node (e.g., an SMF), wherein the message may include a notification that the PMF message has been retransmitted by a maximum number of times.

In example, a WTRU may support an MA PDU session or transmission, and/or a Redundant Steering Mode (RSM). The WTRU may comprise a processor. The WTRU may establish an MA PDU session with a network node (e.g., a UPF). The MA PDU session may be a MA PDU session with redundant steering mode. The WTRU may receive a request message (e.g., a PMF request message) from the network node. The PMF request message may indicate a request to suspend traffic duplication, based on which the WTRU may suspend data transmission or data reception on a first access leg. The WTRU may then determine to resume traffic duplication (e.g., so that the WTRU may send an uplink transmission using the suspended access leg). The WTRU may send a resume request message (e.g., a PMF resume request message) to the network node. The resume request message may indicate a cause for the request. The WTRU may receive a resume response message (e.g., a PMF resume response message) from the network node.

In the example described above, the determination to resume traffic duplication (e.g., to send the uplink transmission using the suspended access leg) may be based on at least one of a loss of connectivity to an active access leg (e.g., a second access leg used by the WTRU for data transmission or data reception while traffic duplication is suspended), a performance measurement or metric based on the active access leg, and/or a start of a service data flow (SDF). In the example described above, the resume request message may further indicate a time for the resumption of traffic duplication (e.g., the time to perform a transmission using the suspended access leg). In the example described above, the resume response message may indicate at least one of an instruction to use the active access leg (e.g., the second access leg), an instruction to use the suspended access leg (e.g., the first access leg), or an instruction to use both the active access leg and the suspended access leg. In response to receive the resume response message, the WTRU may perform the uplink transmission using the active access leg, the suspended access leg, or both the active access leg and the suspended access leg.

In an example, a WTRU may support an MA PDU session or transmission, and/or a Redundant Steering Mode (RSM), The WTRU may comprise a processor. A MA PDU session may be established with RSM. The WTRU may receive a request message (e.g., a PMF request message) from a network node (e.g., a UPF). The request message may indicate a request to suspend traffic duplication and the WTRU may suspend data transmission or data reception on an access leg based on the request message. The WTRU may subsequently determine that an event associated with the suspended access leg may have occurred (e.g., the event may be associated with a change in a serving cell or the termination of an SDF). The WTRU may send an access assistance request message (e.g., via PMF signaling) to the network node based on the event. The access assistance request message may indicate a cause associated with the event.

One or more of the examples described herein may be associated with an MA PDU session. One or more of the examples described herein may use PMF signaling, PMF suspend or PMF resume. The term “access” may be used interchangeably with the term “access leg,” which may be associated with a cellular communication network (e.g., a 3GPP network) or a non-cellular communication network (e.g., a non-3GPP network).

Embodiments disclosed herein may be used to enhance an redundant steering mode (RSM), In an example, a WTRU procedure to suspend traffic duplication may be provided. In an example, a WTRU procedure to deal with WTRU mobility over an active access leg may be provided. In an example, a WTRU procedure to deal with WTRU mobility over an suspended access leg may be provided. In an example, PMF signaling over an MA PDU session may be provided. In an example, a UPF procedure to suspend traffic duplication may be provided.

Embodiments disclosed herein may provide a WTRU and/or a network device (e.g., UPF) with the ability to suspend traffic duplication efficiently and/or to deal with potential mobility issues when traffic duplication is suspended for an MA PDU session. The embodiments may allow the WTRU and/or the network device (e.g., UPF) to use traffic duplication to send PMF messages.

WTRU and/or network device (e.g., UPF) procedures to suspend traffic duplication may be provided. For example, a WTRU procedure may be provided. The WTRU may support MA PDU transmissions and a redundant steering mode (RSM), The WTRU may receive ATSSS rules and/or configuration information regarding suspension of traffic duplication and/or the redundant steering mode. The configuration information may indicate how to operate when traffic duplication is suspended (at least partially) such as what access leg(s) to use when traffic duplication is suspended, the duration of the suspension, and/or a list of SDFs exempted from the suspension.

A WTRU may receive a request message (e.g., a PMF request message) from a network device (e.g., UPF). The request message may indicate a suspension of traffic duplication. The request message may indicate which access leg(s) to use when traffic duplication is suspended (at least partially), when to suspend traffic duplication, the direction of the suspension (e.g., UL and/or DL), and/or the list of SDFs exempted from the suspension. The WTRU may determine which access leg(s) to suspend based on the request message, the configuration information (e.g., including ATSSS rules), and a condition at the WTRU (e.g., power, operating frequency, link performance, etc.). The WTRU may send a response message (e.g., PMF response message) to the network device (e.g., UPF). The response message may include a request to send the WTRU to a power save mode (e.g., on the suspended access leg).

A network device procedure associated with the suspension of traffic duplication may be provided. A network device such as a UPF may support MA PDU transmissions and/or the redundant steering mode. The network device may receive one or more N4 rules. The N4 rules may include configuration information regarding the redundant steering mode and/or how to operate when traffic duplication is suspended. The configuration information may indicate, for example, which access leg to use when traffic duplication is suspended (at least partially), the duration of the suspension, exempted SDFs, and/or how to send suspend/resume messages (e.g., via PMF signaling). The network device may receive an indication from another network device or node (e.g., such as an I-UPF, an SMF, a RAN node, etc.) to suspend traffic duplication. The network device may determine to suspend traffic duplication based on the received indication.

The network device may send a request message (e.g., a PMF request message) to a WTRU to suspend traffic duplication. The request message may indicate what access leg to use when traffic duplication is suspended, when to suspend traffic duplication, the direction of the suspension (e.g., UL and/or DL), and/or a list of exempt SDFs.

The network device may receive a response message (e.g., a PMF response message) from the WTRU. The response message may include an indication to send the WTRU to a power save mode (e.g., on a suspended access leg). The network device may determine if traffic duplication (e.g., in the downlink) should be suspended (e.g., on the suspended access leg reported by the WTRU) based on received response message. The network device may send a message to another network device or node (e.g., a RAN node such as a base station) indicating that an access leg has been suspended

A WTRU procedure to deal with WTRU mobility over an active access leg may be provided. A WTRU may support MA PDU transmissions and/or a redundant steering mode. The WTRU may establish an MA PDU session with the redundant steering mode. The WTRU may receive a request message (e.g., a PMF request message) from a network device (e.g., a UPF). The request message may indicate a suspension of traffic duplication.

The WTRU may determine to stop the suspension of traffic duplication (e.g., to resume sending uplink transmissions over the suspended access leg). This determination may be based on a loss of connectivity to an active access leg (e.g., an access leg used during the suspension of traffic duplication), a performance metric or measurement over the active access leg, the start of an SDF, etc.

The WTRU may send a resume request message (e.g., via PMF signaling) to a network device (e.g., the UPF). The resume request message may include a cause for the request and/or the time when traffic duplication (e.g., data transmissions or receptions) over the suspended access leg should be resumed.

The WTRU may receive a resume response message (e.g., via PMF signaling) from the network device (e.g., the UPF). The response message may indicate whether the WTRU should continue data transmission or data reception on (e.g., only on) the active access leg, restart data transmission or data reception on the suspended access leg, or duplicate data transmission or reception over both access legs.

Responsive to receiving the indication in the resume response message, the WTRU may continue using (e.g., only) the active access leg, stop using the active access leg and begin using the suspended access leg, or start using both access legs.

A WTRU procedure to deal with WTRU mobility over a suspended access leg may be provided. A WTRU may support MA PDU transmissions and/or a redundant steering mode. The WTRU may establish an MA PDU session in the redundant steering mode. The WTRU may receive a request message (e.g., a PMF request message) from a network device (e.g., a UPF) to suspend traffic duplication.

The WTRU may determine whether to inform a network device (e.g., the UPF) about an event detected on a suspended access leg, wherein the event may be a change in a serving cell, the termination of an SDF, etc. The WTRU may send an access assist request message (e.g., via PMF signaling) to the network device (e.g., the UPF). The access assist request message may indicate a cause for the request.

PMF signaling may be performed over an MA PDU session. A WTRU may support MA PDU transmissions. The WTRU may receive configuration information regarding PMF signaling (e.g., via ATSSS rules for the WTRU, via N4 rules for a UPF). The configuration information may indicate how to send a first (e.g., initial) PMF message and/or how to retransmit the PMF message. The WTRU may determine whether to send a PMF message to a network device (e.g., the UPF). The PMF message may include an indication (e.g., a bit field) that the message is a first (e.g., initial) transmission of the PMF message. The WTRU may determine an access leg to use for the first (e.g., initial) PMF message transmission (e.g., based on steering modes and/or related rules).

The WTRU may determine to retransmit the PMF message. The WTRU may include an indication (e.g., by modifying the bit field in the PMF message) that the message is a retransmission. The WTRU may determine an access leg to use for the retransmission of the PMF message (e.g., based on steering modes and/or related rules). The WTRU may send a notification to a network device (e.g., an SMF) if the PMF message has been retransmitted a maximum number of times.

One or more of the WTRU operations described herein may be performed by a network device such as, for example, a UPF.

A WTRU may be capable of both 3GPP access and non-3GPP access. These capabilities may provide flexibility to network operators in determining which access to use for a service data flow. A WTRU using both accesses may be requested to establish independent single-access PDU sessions over an access (e.g., over each access).

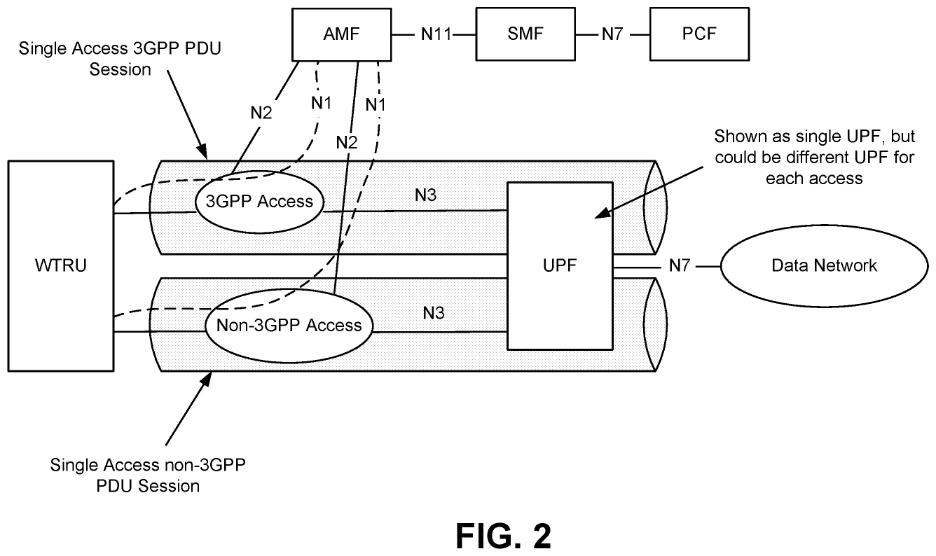

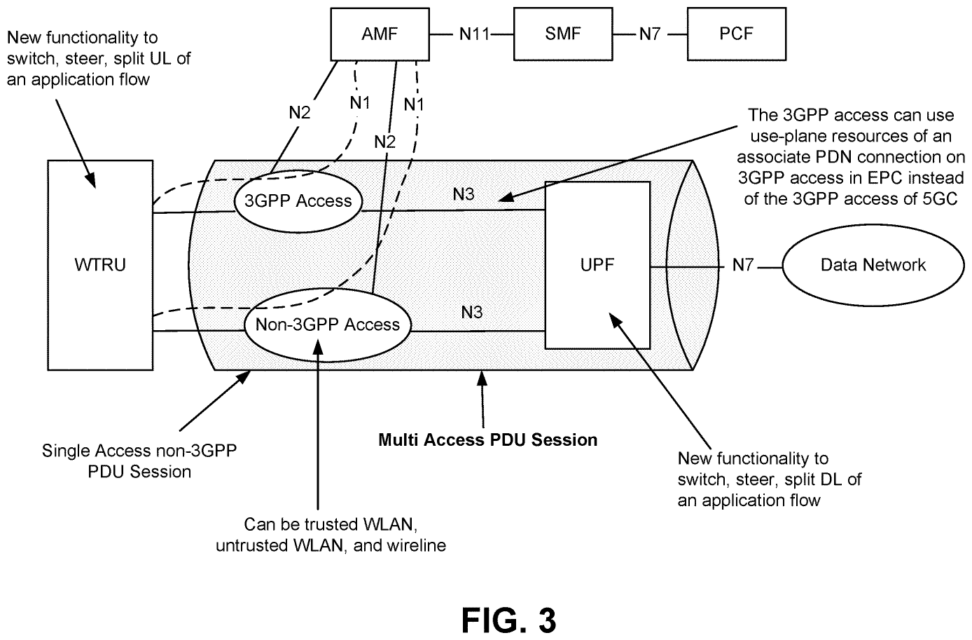

FIG. 2 is a system diagram illustrating an example of a WTRU with 3GPP and non-3GPP accesses. A multi-access PDU (MA PDU) session may be established to allow uplink and downlink traffic of a service data flow to be steered, switched, and/or split between accesses (e.g., as shown in FIG. 3). Traffic associated with the MA PDU session may be sent over a 3GPP access, a non-3GPP access, or both accesses.

FIG. 3 is a system diagram illustrating another example of a WTRU with 3GPP and non-3GPP accesses. The example shown in FIG. 3 may allow for steering functionality, which may include access traffic steering that may be applicable between 3GPP and non-3GPP accesses. Steering functionality may include access traffic switching, which may include moving all or part traffic of an ongoing data flow from one access network to another access network in a way that maintains the continuity of the data flow. Access traffic switching may be applicable between 3GPP and non-3GPP accesses.

Steering functionality may include access traffic splitting, which may split the traffic of a data flow across multiple access networks. When traffic splitting is applied to a data flow, some traffic of the data flow may be transferred using one access, and another part of the same data flow may be transferred using another access. Access traffic splitting may be between 3GPP and non-3GPP accesses.

The steering functionality in an ATSSS-capable WTRU may steer, switch and/or split traffic associated with an MA PDU session across a 3GPP access and a non-3GPP access. One or more of the following steering functionalities may be provided. A first functionality may be a high-layer steering functionality (e.g., which may operate above the IP layer). The high-layer steering functionality may apply to the MPTCP protocol (e.g., IETF RFC 8684) and may be called “MPTCP functionality.” This functionality may be applicable (e.g., only applicable) to TCP traffic. A second functionality may be a low-layer steering functionality (e.g., which may operate below the IP layer). A type of low-layer steering functionality may be referred to as “ATSSS Low-Layer functionality” or ATSSS-LL functionality. The ATSSS-LL functionality may be applicable to Ethernet and IP (e.g., TCP and UDP). The steering functionality may be a functionality that exists in both a WTRU and a network device such as a UPF (e.g., the endpoints of a PDU session).

With the steering functionality, a number of steering modes may be possible. The steering mode may determine how the traffic of a matching service data flow may be distributed across multiple accesses, such as a 3GPP access and a non-3GPP access. The steering modes may include an active standby mode. The active standby mode may be used to steer traffic to an access (e.g., an active access) when the access is available, and/or to switch traffic to another access (e.g., a standby access) when the previously used access becomes unavailable.

The steering modes may include a Smallest Delay mode. The Smallest Delay mode may be used to steer traffic to the access that may be determined to have the smallest Round-Trip Time (RTT). A WTRU and/or a network device (e.g., such as a UPF) may measure an RTT in order to determine which access has the lowest RTT. This mode may be used for a non-GBR SDF.

The steering modes may include a Load Balancing mode. The Load Balancing mode may be used to split traffic across multiple (e.g., two) access legs according to a percentage of how much traffic may be sent over each access leg (e.g., a 3GPP access leg or a non-3GPP access). This mode may be used for a non-GBR SDF.

The steering mode may include a priority based mode. The priority based mode may be used to steer the traffic (e.g., all the traffic) to a high priority access in a manner that matches a Policy and Charging Control (PCC) rule, until this access is determined to be congested. In this case, the traffic (e.g., part of the traffic) may be sent to a low priority access (e.g., the traffic may be split over the high priority and low priority accesses). This mode may be used for (e.g., only for) a non-GBR SDF.

One or more of the steering modes described above may be enhanced. For the Load Balancing mode, a steering mode indicator may be used, which may indicate that a WTRU may change the default steering parameters provided in a steering mode component and may adjust traffic steering based on its own decisions. The steering mode indicator may be an autonomous load-balance indicator. When such an indicator is provided, the WTRU may ignore the percentages in the steering mode component (e.g., the default percentages provided by the network) and autonomously determine its own percentages for traffic splitting in a way that may maximize the aggregated bandwidth in the uplink direction. The steering mode indicator may be a WTRU-assistance Indicator. When provided by the network, the indicator may indicate that the WTRU may decide how to distribute the traffic (e.g., UL traffic) of a matching SDF based on the WTRU's internal state (e.g., when the WTRU is in a special internal state such as at a lower battery level). In examples, the WTRU-assistance indicator may indicate that the WTRU should inform the network (e.g., a UPF) about how it distributes the UL traffic of a matching SDF. In examples, even if the WTRU-assistance indicator is provided, the WTRU may still distribute traffic (e.g., UL traffic) as indicated by the network.

A threshold value may be provided and used for the load balancing steering mode. The threshold values may be a value associated with an RTT or a packet loss rate. The threshold values may be applicable to multiple (e.g., two) accesses (e.g., access legs) and may be applied by a WTRU and/or a network device (e.g., a UPF), If a measured parameter (e.g., an RTT or a packet loss rate) on an access exceeds the threshold value, the WTRU and/or network device may stop sending traffic on the access, or they may continue transmitting traffic on the access but may reduce the traffic transmitted on the access by a certain amount (e.g., which may be implementation specific and/or configurable), The WTRU and/or network device may send the reduced traffic on another access. When one or more measured parameters (e.g., the RTT and/or the packet loss rate) for the accesses do not exceed the threshold values, the WTRU and/or network device apply fixed split percentages to the accesses.

A threshold value may be provided for the priority-based steering mode. The threshold value may be a value associated with an RTT or a packet loss rate. The threshold value may be applicable to multiple (e.g., two) accesses and may be applied by a WTRU and/or a network device (e.g., a UPF). The threshold value may be considered by the WTRU and the network device to determine when an access becomes congested. For example, if a measured parameter (e.g., the RTT or the packet loss rate) on one access exceeds the threshold value, the WTRU and/or network device may consider the access congested and may send traffic (e.g., part of the traffic) to a low priority access.

To enable steering modes, rules may be used by a WTRU and/or a network device (e.g., a UPF). These rules may be generated by a network device such as an SMF based on information known to another network device such as a PCF. The rules may be sent to the WTRU (e.g., as ATSSS rules) to determine the switching functionality and/or switching mode for UL traffic. The rules may be sent to a network device such as the UPF (e.g., as N4 rules) to determine the switching functionality and/or switching mode for DL traffic.

To support some of the steering modes, a performance management function (PMF) protocol may be used by a WTRU and a network device (e.g., the UPF) to make/report the measurements necessary for switching mode decisions (e.g., round trip time measurements, access availability/unavailability report, and/or packet loss rate).

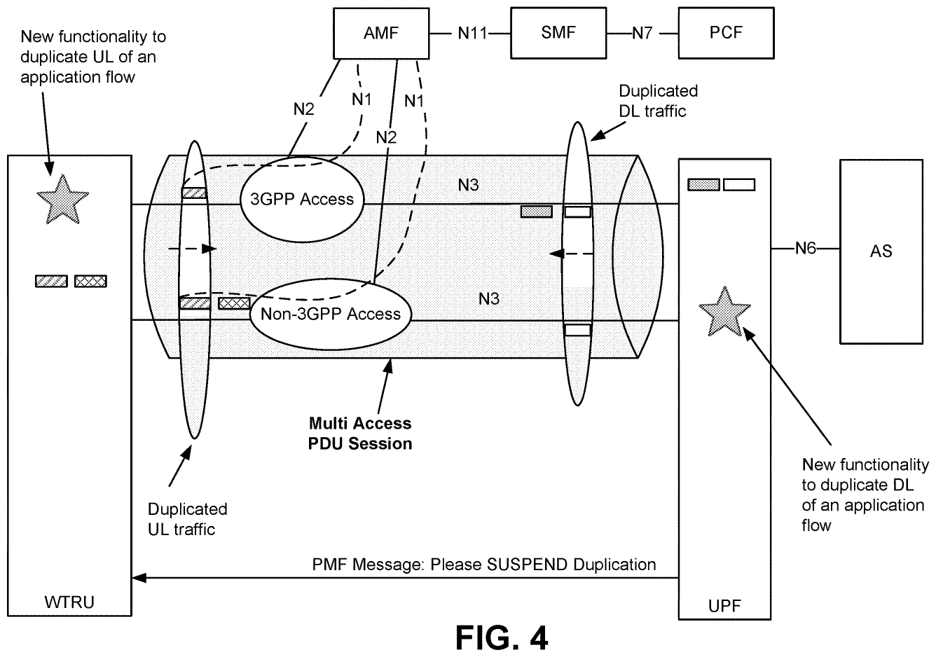

FIG. 4 is a system diagram illustrating an example of providing a redundant steering mode (RSM). The RSM may be considered a steering mode that may allow a WTRU and/or a network device (e.g., a UPF) to duplicate traffic over multiple (e.g., two) access legs of an MA-PDU session. FIG. 4 illustrates some of the functionalities associated with the RSM. A WTRU may be configured with ATSSS rules associated with the RSM. A network device such as a UPF may be configured with N4 rules associated with the RSM. These rules may inform the WTRU and/or the network device about which traffic may be duplicated. Multiple (e.g., three) modes of RSM may be provided.

In a first mode, which may be referred to herein as “Static and WTRU/UPF configured with a Primary Access”, a WTRU and/or a UPF may send traffic over a primary access (e.g., a primary access leg), and the WTRU and/or UPF may duplicate the traffic over a secondary access (e.g., a secondary access leg) when that may be needed. The primary access may be provided to the WTRU via one or more ATSSS rules and to the UPF via one or more N4 rules. The amount of traffic to duplicate may be configurable and/or left to WTRU/UPF implementation.

In a second mode, which may be referred to herein as “Static and WTRU/UPF not configured with a Primary Access,” a decision to duplicate traffic may be static. A WTRU and/or a UPF may (e.g., always) duplicate traffic over a primary access and a secondary access.

In a third mode, which may be referred to herein as “Dynamic with a requirement,” the decision to duplicate traffic may be dynamic. A WTRU/UPF may duplicate traffic based on a primary access, a configured requirement, a requirement related to a packet loss rate (PLR) or a round trip time (RTT), and/or measured performance over the primary access and/or a secondary access. The primary access may be configured via one or more ATSSS rules to the WTRU and via one or more N4 rules to the UPF. If not configured with such rules, the WTRU and/or the UPF may determine the primary access based on their own implementation.

A WTRU and/or a network device (e.g., a UPF) may use a number of rules to determine if traffic duplication may be used for a packet. In an example, if a measured performance on a first access leg does not meet a requirement, and a measured performance on a second access leg does meet the requirement, the WTRU and/or the network device may decide to transmit traffic on the second access leg. In an example, if a requirement (e.g., a performance requirement) is met on both accesses, the WTRU and/or the network device may decide to transmit traffic over (e.g., only over) a primary access. In an example, if a PLR measurement does not meet a requirement on both a first primary access and a secondary access, the WTRU and/or the network device may duplicate traffic on both accesses. In an example, if an RTT measurement does not meet a requirement on both a primary access and a secondary access, the duplication decision may be left to WTRU and/or network device implementation. For example, if the WTRU determines that traffic duplication may help to achieve the RTT requirement, then the WTRU may decide to duplicate the traffic. If, on the other hand, the WTRU determines that duplication may not help to achieve the RTT requirement, then the WTRU may decide not to duplicate the traffic.

A network device such as a UPF may suspend and resume traffic duplication. This may be achieved by sending a message (e.g., a PMF message) to a WTRU. The network device may determine to suspend traffic duplication in an implementation specific way. For example, a suspension may be initiated by the network device in cases of locally detected congestion (e.g., at the network device), Suspending uplink traffic duplication may allow the network device to stop receiving duplicated traffic via multiple accesses (e.g., a 3GPP access and a non-3GPP access simultaneously). In the message sent to the WTRU, the network device may provide one or more of the following indications: suspend traffic duplication for GBR traffic, suspend traffic duplication for non-GBR traffic, or suspend traffic duplication for all uplink traffic. The network device may send the message over an (e.g., any) available access channel.

Traffic Duplication may be suspended and/or resumed. The redundant steering mode (RSM) described herein may allow a WTRU and/or a network device (e.g., a UPF) to duplicate traffic over multiple (e.g., two) access legs of an MA-PDU session. The duplication may be configured to be static or dynamic. In examples, the network device may be allowed to suspend traffic duplication via PMF signaling and later resume traffic duplication also via PMF signaling.

A number of issues may be addressed to enable suspension or resumption of traffic duplication, A first issue may be that a WTRU and/or a network device (e.g., a UPF) may not have configuration information related to how the WTRU should operate when traffic duplication is suspended. Without such configuration information, when traffic duplication is suspended, the WTRU may default to using an active or standby access, but in some cases, this may not be optimal. A second issue may be that the WTRU may not have been configured with logics for determining what to do when traffic duplication is suspended.

A mechanism for suspending and resuming traffic duplication may address a number of inefficiencies. A first inefficiency may be related to triggering a suspension or resumption of traffic duplication based on UPF implementation and not giving a network device the ability to signal the suspension or resumption of traffic duplication to the UPF. A second inefficiency may be related to an access network(AN) node not having knowledge about (e.g., unaware of) the suspension or resumption of traffic duplication and, as a result, not being able to optimize resource allocation.

In some RSM implementations, PMF signaling may be performed over the user plane between a WTRU and a UPF, while the RSM may be used for (e.g., only for) service data flows. As a result, the WTRU (or UPF) in these implementations may not duplicate PMF signaling over multiple (e.g., two) access legs. It may be inefficient to leave the choice of which access leg to use to perform PMF signaling to the WTRU (or UPF). Embodiments described herein may allow PMF signaling to use traffic duplication.

The behavior of MA-PDU sessions when traffic duplication is suspended and/or when a WTRU changes serving cells may be configured (e.g., defined). When traffic duplication is suspended, the traffic for which duplication is suspended may be sent on an active access leg, and another access leg may be referred to as a dormant access leg (e.g., during suspension of traffic duplication, the dormant access leg may not carry traffic for which duplication has been suspended). In some examples, the WTRU may not know what to do if the WTRU loses connectivity on the active access leg or if the WTRU changes an AN node on the dormant access leg (e.g., as a result of cell reselection or handover). Embodiments described herein may allow the WTRU to know what to do if the WTRU loses connectivity on the active access leg or if the WTRU changes the AN node on the dormant access leg (e.g., as a result of a cell reselection or handover).

In the examples provided herein, the term “access” may be used to refer to an access mechanism between a WTRU and a network. The network may be a cellular (e.g., 3GPP) network or a non-cellular (e.g., non-3GPP) network. For example, the non-3GPP network may be a WiFi network.

In the examples provided herein, the terms “access,” “access leg” and “access path” may be used interchangeably and may refer to a combination of access and N3 interface between a WTRU and a network device (e.g., a UPF). In the examples provided herein, multiple (e.g., two) access legs may be used for ATSSS including, for example, a 3GPP access leg and a non-3GPP access leg.

In the examples provided herein, the term “duplication” may refer to a redundant steering mode functionality with which traffic may be duplicated across multiple (e.g., two) access legs. In the examples provided herein, the terms “suspension” and “suspending duplication” may be used interchangeably and may refer to the case in which a WTRU and/or a network device (e.g., a UPF) are using the redundant steering mode, and the WTRU and/or the network device has determined to suspend traffic duplication.

In the examples provided herein, the term “active access leg” may refer to an access leg (e.g., of an MA-PDU session) on which traffic transmission or reception is not suspended (e.g., an active access leg is the access leg on which traffic is sent or received during suspension of traffic duplication).

In the examples provided herein, the term “suspended access leg” may refer to an access leg (e.g., of an MA-PDU session) on which transmission or reception of traffic (e.g., data and/or control information) associated with a specific service data flow is suspended (e.g., traffic from the service data flow may not be sent on the suspended access leg during suspension of traffic duplication).

In the examples provided herein, the term “steering mode” may refer to how traffic may be split, steered, switched, or duplicated across multiple access legs (e.g., two access legs). For ATSSS, one or more of the following steering modes may be provided: Active-Standby, Load Balancing, Priority, Smallest Delay, and Redundant Steering Mode. It should be noted that “steering mode” is not limited to only ATSSS steering modes, and can include other steering modes.

A WTRU and a network device (e.g., a UPF) may exchange information (e.g., related to performance management and/or control signaling) using the PMF protocol. The WTRU and the network device may also use other performance management protocols. A performance management protocol may be implemented over MP-QUIC, MP-TCP, or MP-DCCP, when ATSSS is based on one or more of those higher layer steering functionalities. For example, measurements and control messages may be sent over one or more MP-QUIC frames.

Embodiments described herein may provide enhancements to the redundant steering mode. A procedure to suspend traffic duplication may be provided. A procedure at a WTRU and/or a network device (e.g., a UPF) that allows PMF signaling to be duplicated may be provided. A procedure at a WTRU and/or a network device (e.g., a UPF) for an MA-PDU session, e.g., when traffic duplication is suspended and/or when a serving cell is changed, may be provided.

Embodiments described herein may enable a WTRU and/or a network device (e.g., a UPF) to suspend traffic duplication efficiently, to deal with potential mobility issues when traffic duplication is suspended for an MA-PDU session, etc. The embodiments may allow the WTRU and/or the network device to take advantage of traffic duplication for sending PMF messages.

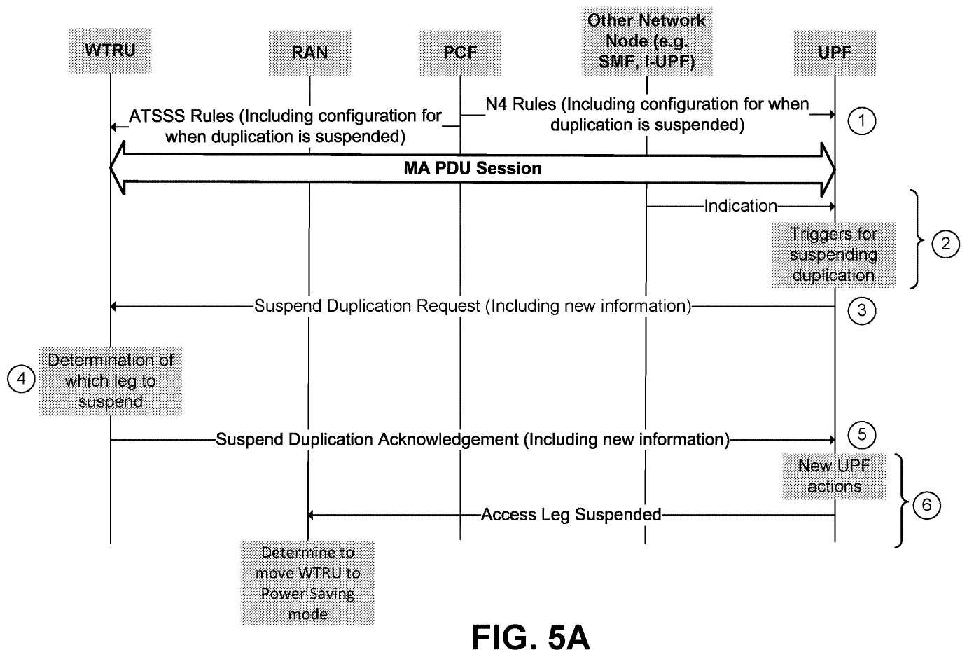

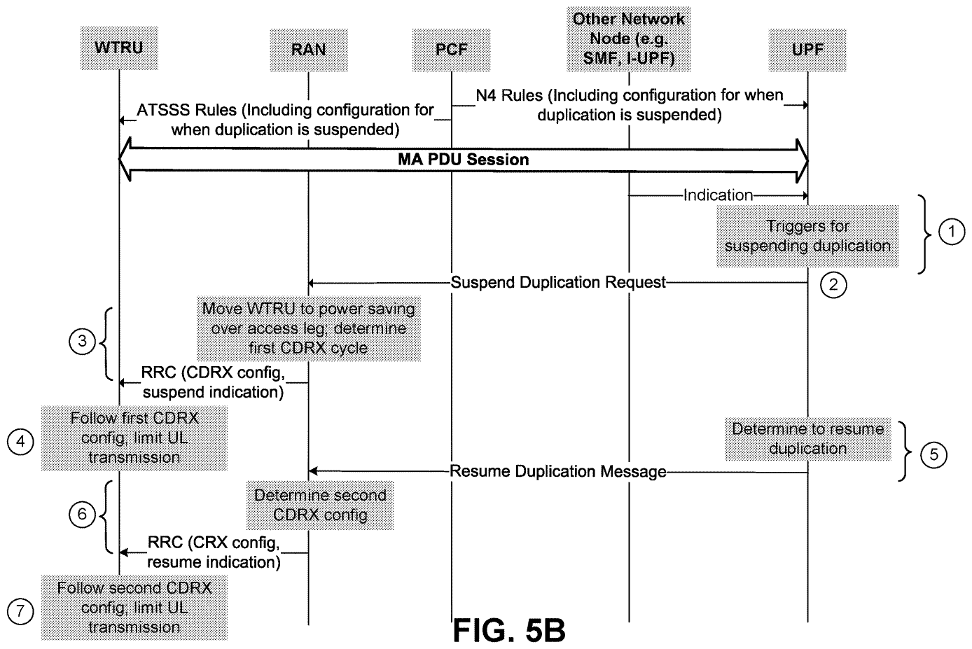

FIG. 5A is a chart illustrating an example of suspending traffic duplication. For ease of description, the example of FIG. 5A assumes that a WTRU and/or a network device (e.g., UPF) has requested the setup of an MA-PDU session.

At 1 of FIG. 5A, the WTRU may receive (e.g., via a PMF message from a PCF) one or more rules (e.g., ATSSS rules) that may include configuration information regarding the WTRU's behaviors during suspend and/or resumption of traffic duplication. The configuration information may, for example, indicate an access to use when traffic duplication is suspended. The configuration information may be for uplink transmissions, for downlink receptions, or for both uplink transmissions and downlink receptions.

The configuration information may indicate a steering mode to use when traffic duplication is suspended. The steering mode may be, for example, Active-Standby, Smallest Delay, Priority, Load balancing, etc. The configuration information may include configuration parameters associated with the steering mode.

The configuration information may indicate a duration of the duplication suspension, which may be the duration of time over which traffic duplication may be suspended. The duration may be relative to the time the PMF message is received. For example, a duration of K msec may imply that the suspension should last from the time a PMF message indicating the suspension was received (T1) to T1+K msec. As another example, the duration may be specified via a start time and an end time.

The configuration information may indicate a duplication cycle or periodicity, which may be a cycle or periodicity over which the WTRU may alternate between time periods where it does not duplicate traffic and time periods where it does duplicate traffic. The duplication cycle or periodicity may be indicated by a length or time period of the cycle, and, within the cycle or periodicity, the start/end time for suspending duplication and the start/end time of activating duplication.

The configuration information may indicate whether an SDF may be exempted from the suspension of traffic duplication. For example, some SDFs may carry traffic of high priority for which the network may prefer not to suspend traffic duplication, so the WTRU may continue duplicating traffic for these SDFs even if traffic duplication may be suspended.

At 1 of FIG. 5A, the network device (e.g., the UPF) may receive (e.g., via a PMF message from the PCF) one or more N4 rules, which may include configuration information regarding the network device's behavior during suspension and/or resumption of traffic duplication. The configuration information may indicate an access to use when traffic duplication is suspended. This may be provided for downlink transmissions, for uplink receptions, or both for downlink transmission and uplink receptions.

The configuration information may indicate a steering mode to use when traffic duplication is suspended. This steering mode may be, for example, Active-Standby, Smallest Delay, Priority, Load balancing, etc. The configuration information may include configuration parameters associated with these steering modes.

The configuration information may indicate a duration of the duplication suspension, which may be the time period over which traffic duplication may be suspended. The duration may be specified relative to the time the PMF message is transmitted. The duration may be specified by a start time and an end time.

The configuration information may indicate a duplication cycle or periodicity, which may be the cycle or periodicity over which the network device (e.g., the UPF) may alternate between time periods where it does not duplicate traffic and time periods where it does duplicate traffic.

The configuration information may indicate whether a SDF may be exempted from the suspension of traffic duplication. For example, some SDFs may carry traffic of high priority, for which the network may prefer not to suspend traffic duplication, and the network device (e.g., the UPF) may continue duplicating traffic for these SDFs even if traffic duplication is suspended.

The configuration information may indicate manners for transmitting a PMF message that may be used to signal the suspension of traffic duplication. The network device (e.g., the UPF) may be configured to transmit the PMF message on one access leg or on multiple (e.g., two) access legs. The network device (e.g., the UPF) may be configured to retransmit the PMF message a certain number of times if the PMF message is not acknowledged by a WTRU. The network device (e.g., the UPF) may be configured to retransmit the PMF message over a different access leg (different from the first transmission). The PMF message may be retransmitted over multiple (e.g., two) access legs (using duplication) in some cases.

At 2 of FIG. 5A, the network device (e.g., the UPF) may be triggered to suspend traffic duplication. The trigger may be based on one or more conditions at (e.g., internal to) the network device (e.g., load on N3 interfaces). The trigger may be based on signaling from other network nodes. The trigger may be referred to herein as a duplication suspension trigger and may be based on one or more of the following.

The duplication suspension trigger may be based on an indication from an intermediate UPF. For example, an intermediate UPF may determine that it has a storage issue or a load issue, and may send an indication to a PDU Session Anchor (PSA) UPF about the issue, In response, the PSA UPF may decide to suspend duplication to try to alleviate the issue at the intermediate UPF.

The duplication suspension trigger may be based on an indication from an SMF. For example, an SMF may be preparing to change a PDU session anchor, and may send an indication about the change to the UPF. The UPF may decide to suspend traffic duplication while the anchor is being changed. As another example, the SMF may be preparing to change an intermediate UPF, and it may send an indication about the change to a PSA UPF. The PSA UPF may decide to suspend traffic duplication while the intermediate UPF is being changed.

The duplication suspension trigger may be based on an indication from a WTRU. For example, a WTRU may experience power issues and may not want to use two access legs. To save power, the WTRU may send an indication to the UPF, and the UPF may decide to suspend traffic duplication to help the WTRU save power.

The duplication suspension trigger may be based on an indication from an AN node. For example, an NG RAN node may determine that a WTRU may perform a handover to a cell. The NG RAN node may send an indication about the handover to the UPF, and the UPF may decide to suspend traffic duplication for this WTRU in order to reduce the traffic forwarding between NG RAN nodes during the handover procedure and/or to minimize service interruption during the handover procedure.

At 3 of FIG. 5A, the network device (e.g., the UPF) may request the WTRU to suspend traffic duplication. The network device may send this request via a request message (e.g., using PMF signaling). The network device may indicate, in the request message, the type of traffic (GBR and/or non-GBR) for which duplication should be suspended. The network device may include one or more of the following information in the request message.

An example of the information sent at 3 of FIG. 5A may be the period of time during which duplication may be suspended. The network device (e.g., the UPF) may suspend traffic duplication during the indicated time period or until a resume message is sent/received. For example, the network device may signal in the request message (e.g., the PMF message) that the suspension may last K msecs. The network device may also indicate the duration by specifying a start time and a stop time for the suspension.

An example of the information sent at 3 of FIG. 5A may be a cycle or periodicity of the suspension, for example, if the network device decides to suspend duplication following a certain cycle or periodicity.

An example of the information sent at 3 of FIG. 5A may be a direction of the suspended duplication. For example, the network device may indicate that duplication may be suspended for (e.g., only for) UL transmissions from the WTRU, for (e.g., only for) downlink transmissions to the WTRU, or for both uplink and downlink transmissions.

An example of the information sent at 3 of FIG. 5A may be a steering mode to use during the suspension of traffic duplication. For example, the network device may determine that, when duplication is suspended, the WTRU may use another steering mode, such as an active standby mode.

An example of the information sent at 3 of FIG. 5A may be an access to use during the suspension of traffic duplication. For instance, the network device may determine the access leg to use when duplication is suspended. As another example, the network device may indicate to the WTRU that the decision may be left to the WTRU or that the WTRU may use a primary access configured in the ATSSS rules.

An example of information sent at 3 of FIG. 5A may be a list of SDFs for which the suspension of traffic duplication may not apply. This may be because some SDFs may have requirements for PLR and/or RTT, and suspending duplication for those SDFs may prevent the network from meeting those requirements.

In one or more of the examples of information sent at 3 of FIG. 5A, if the information is missing from the request message (e.g., sent via PMF signaling), the WTRU may have a default behavior. For example, if the network device does not provide an access to use, the default behavior for the WTRU may be that the WTRU may decide the access to use, or that the WTRU may use a primary access configured in the ATSSS rules.

At 4 of FIG. 5A, the WTRU may determine which access to suspend based on one or more of the following criteria. Under an example criterion, the WTRU may determine the access leg to suspend based on information carried in the suspension request message (e.g., received from the UPF). Under an example criterion, the WTRU may determine the access leg to suspend based on an implicit indication received from the network device. For example, the WTRU may receive the suspension request message on access leg 1, and the WTRU may take this as an indication to suspend traffic duplication on access leg 1. As another example, the WTRU may receive the suspension request message on access leg 1, and may take this as an indication to suspend traffic duplication on access leg 2.

Under an example criterion, the WTRU may determine an access leg to suspend based on power consumption by the WTRU. For example, the WTRU may determine that a first access leg uses more power than a second access leg, and decide to suspend traffic duplication over the first access leg.

Under an example criterion, the WTRU may determine an access leg to suspend based on an operating frequency or frequency band used by the WTRU. For example, the WTRU may prefer one frequency or frequency band over another (e.g., prefer to use an unlicensed spectrum when available, or prefer not to use the FR2 frequency band), and may determine to suspend the access leg associated with the unpreferred frequency or frequency band.

Under an example criterion, the WTRU may determine an access leg to suspend based on connectivity to a network device (e.g., an access network node). For example, the WTRU may prefer a WLAN connection over a cellular connection, and may determine to suspend the access leg associated with the cellular connection. As another example, the WTRU may prefer not to use a satellite-based cellular connection or an indirect cellular connection (e.g., which involves one or more relays), and determine to suspend the access leg associated with the unpreferred connection. As another example, the WTRU may prefer not to use a non-trusted WLAN connection and may suspend the access leg associated with the non-trusted WLAN connection.

Under an example criterion, the WTRU may determine an access leg to suspend based on performance metrics such as a packet loss rate (PLR) and/or a round trip time (RTT). For example, the WTRU may prefer to use the access leg that better meets PLR and/or RTT requirements.

It should be noted that the WTRU may use the criteria described herein for determining the access leg to use or suspend even if the WTRU does not agree with the recommendation/request from the network device (e.g., from the UPF).

At 5 of FIG. 5A, the WTRU may acknowledge that it has received the suspension request from the network device (e.g., the UPF). The WTRU may send the acknowledgment to the network device via a response message (e.g., a PMF response message). The WTRU may provide additional information in the response message including, for example, one or more of the following. The WTRU may indicate, in the response message, a duration of the suspension (e.g., how long the WTRU may suspend traffic duplication). The WTRU may indicate, in the response message, a cycle or periodicity of the suspension (e.g., if the WTRU decides to suspend traffic duplication following a certain cycle or periodicity). The WTRU may indicate, in the response message, an access leg to use while traffic duplication is suspended. For example, if the WTRU determines an access leg to use during the suspension of duplication, the WTRU may provide this information to the network device. The WTRU may indicate, in the response message, a request to send the WTRU to a power saving mode over the suspended access leg.

At 6 of FIG. 5A, the network device (e.g., the UPF) may perform an action upon reception of the acknowledgement from the WTRU. In an example action (e.g., in cases where the WTRU acknowledges that it may suspend uplink traffic duplication), the network device may decide whether to also suspend downlink traffic duplication. In an example action, if the network device determines that traffic duplication may be suspended in both uplink and downlink directions for an access leg, the network device may inform the AN node associated with the access leg about the suspension, and the AN node may use this information to decide whether to move the WTRU to a power-saving state. In an example action, if the WTRU acknowledgment includes a request to move the WTRU to a power-saving state over an access leg, the network device may inform the AN node of the access leg about the request, and the AN node may use this information to decide whether to move the WTRU to the power-saving state.

In the example illustrated in FIG. 5A, the WTRU may determine to suspend traffic duplication based on a power saving message received from an access node. In this example, the WTRU and network device (e.g., the UPF) may establish a MA PDU session and may be configured to use a redundant steering mode for one or more SDFs.

FIG. 5B is a diagram illustrating an example of suspending traffic duplication based CDRX configuration information. As shown in FIG. 5B, at 1, the UPF may be triggered to suspend duplication. The trigger may be based on conditions internal to the UPF (e.g., load on N3 interfaces). The trigger may also be based on a periodic suspend-resume cycle determined by the UPF based on redundant steering configuration, such as a percentage of replication. The trigger may be based on signaling from other network nodes, such as a duplication suspend trigger from the SMF, an access network node, or an intermediate UPF. For example, the UPF may determine to suspend duplication over access leg 1.

At 2 of FIG. 5B, the UPF may send a message to the radio access network (RAN) node of an access leg (e.g., access leg 1), to notify the RAN node about the suspended duplication of traffic on access leg 1. The notification message may include a suspend/resume cycle or periodicity (e.g., including a period or a suspend and/or resume time interval within the period). The notification message may include an indication to suspend traffic duplication. The notification message may include an WTRU identifier. The notification message may include a list of SDFs for which traffic duplication may be suspended. The notification message may include a PDU session ID that may Identify the MA-PDU session associated with the suspension of traffic duplication.

At 3 of FIG. 5B, the RAN node (e.g., of access leg 1), based on the contents of a suspension notification message (e.g., from the UPF), may send a power saving message (e.g., via RRC signaling) to the WTRU. The RAN node may determine to send the power saving message based on a determination that there may not be traffic enqueued towards the WTRU on any PDU session and/or that no traffic may be sent to the WTRU over a period of time corresponding to the suspend/resume cycle or periodicity from the notification message (e.g., the RAN node may make this determination based on the notification message from the UPF). The power saving message may indicate a connected mode discontinuous reception (CDRX) configuration. The CDRX configuration may match the suspend/resume cycle or periodicity received from the UPF. In an example, the power saving message may include a “GoToSleep” indication for the WTRU. The power saving message may be sent via RRC signaling, for example, using an RRCReconfiguration message, through MAC layer signaling (e.g., via a MAC CE), and/or through physical layer signaling (e.g., via a DCI). The message may include an indication that the cause for the power saving message is traffic duplication suspension requested by the UPF.

At 4 of FIG. 5B, the WTRU may receive the power saving message and may limit uplink transmissions according to the power saving message. If the message indicates “GoToSleep,” the WTRU may stop sending traffic over the corresponding access leg (e.g., stop duplication over this access leg). In an example, if the WTRU receives a CDRX configuration, WTRU may stop uplink transmissions on the access leg (e.g., WTRU may stop duplicating traffic on this access leg) during the CDRX OFF periods.

In examples, the UPF may determine (e.g., subsequent to suspending traffic duplication) to resume traffic duplication, as shown at 5 of FIG. 5B. As a result, the UPF may (e.g., at 5 of FIG. 5B) send a resume indication to the RAN node (e.g., of access leg 1). In response, the RAN node may (e.g., at 6 of FIG. 5B) send a power saving message (e.g., via RRC signaling) to the WTRU, which may include a CDRX configuration (e.g., a new CDRX configuration) or a “WakeUp” signal. Based on the power saving message, the WTRU may (e.g., at 7 of FIG. 5B) act according to the contents of the message (e.g., the WTRU may resume duplicating traffic over access leg 1).

A WTRU and/or a network device (e.g., a UPF) may implement procedures to enable duplication of PMF signaling. The PMF signaling may be between a transmitting entity and a receiving entity, wherein the transmitting entity may be a WTRU or a UPF, and the receiving entity may be the UPF or the WTRU, respectively. The WTRU and UPF may be configured to allow PMF messages to be duplicated (e.g., over multiple access legs). In such a case, ATSSS rules for the WTRU and N4 rules for the UPF may include a rule (e.g., a dedicated rule) for PMF signal duplication. For example, a rule may include a Traffic Descriptor component (e.g., “PMF signaling”), which may indicate that the rule may be applicable to PMF signaling. As another example, the ATSSS rules to the WTRU and the N4 rules to the UPF may include an indication of whether a rule may be applicable to PMF signaling. For example, a Traffic Descriptor component of the rules may have one or more of an “Application descriptors” field, an “IP descriptors” field, a “Non-IP descriptors” field, and/or a “Also applicable to PMF signaling” field, which may indicate to the WTRU or the UPF that the rule may be applied to SDF(s) that match the traffic descriptor as well as to PMF signaling. The WTRU and the UPF may rely on existing traffic descriptors and treat the PMF as another application. The N4 rules and the ATSSS rule may include a rule for an “PMF application.” The PMF may have a reserved application identity (e.g., which may include a reserved OSId and/or an OSAppid) that may be known to both the WTRU and the UPF. In an example, the WTRU and/or the UPF may rely on existing traffic descriptors and treat the PMF as another application with a special IP descriptor. For example, a 5-tuple may have a source IP address set to a PMF IP address and a source port set to a PMF UDP port associated with a non-3GPP access or to a PMF UDP port associated with a 3GPP access. The rule may include a field (e.g., a new field) to identify whether the rule is applicable to a first (e.g., initial) PMF transmission or a PMF retransmission.

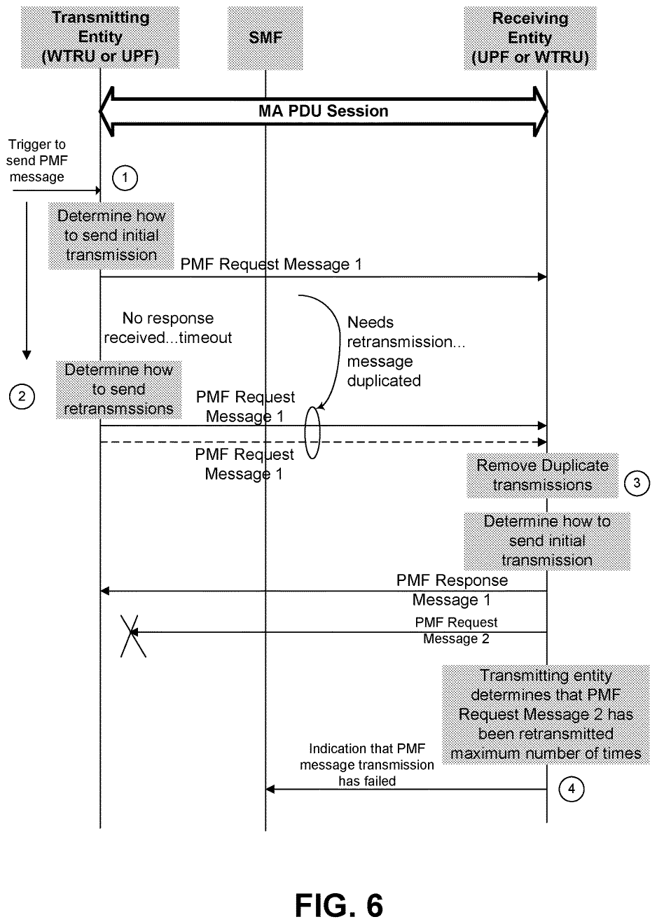

FIG. 6 illustrates example actions at a transmitting entity and a receiving entity for the case where PMF signaling may be performed in a redundant steering mode (e.g., to allow duplication of the PMF signaling). It should be understood that PMF signaling may use any steering mode (e.g., not only the redundant steering mode). For ease of description, it may be assumed in the example of FIG. 6 that an MA-PDU session has been established, and that ATSSS rules and N4 rules allow PMF signaling to be duplicated over multiple (e.g., two) access legs. The ATSSS/N4 rules may include a rule applicable to first (e.g., initial) transmissions of PMF messages (herein referred to as an “initial PMF transmission rule”) and/or a rule applicable to retransmissions of PMF messages (herein referred to as a “PMF retransmission rule”).

At 1 of FIG. 6, a transmitting entity may be triggered to send a PMF message. If duplication is enabled for PMF messages, the transmitting entity may determine which access leg to use to send this PMF message. This decision may be based on one or more of the following initial PMF transmission rules. In an example initial PMF transmission rule, the transmitting entity may duplicate (e.g., always duplicate) the PMF message over both accesses. In an example initial PMF transmission rule, the transmitting entity may select the best access leg based on measured performance. For example, this may be based on RTT or PLR measurements. In an example initial PMF transmission rule, the transmitting entity may select the access leg based on the type of the PMF message. If the PMF message is a performance-based PMF message, the transmitting entity may send the PMF message on the access leg over which the performance may be measured. If the PMF message relates to suspending traffic duplication, the transmitting entity may send the PMF message on the access leg that may not be suspended.

In an example initial PMF transmission rule, the transmitting entity may respond to or acknowledge a PMF request message from the receiving entity, in which case the transmitting entity may select the same access leg that was used for the PMF request message. In an example, the PMF request message may indicate how the PMF response/acknowledgment may be to be sent. In an example, the PMF request message may indicate that the response message may be duplicated.

Some PMF request messages may be retransmitted by the transmitting entity if the PMF request messages are not responded to or acknowledged by the receiving entity. These may include PMF messages to signal access availability/unavailability, PMF messages to send WTRU-assistance data to a UPF, and/or PMF messages related to suspending traffic duplication. The transmitting entity may start a timer when a PMF request message is triggered or transmitted. If a response or acknowledgment is not received before the timer expires, the transmitting entity may decide to retransmit the PMF message. As shown at 2 of FIG. 6, PMF Request Message 1 may be retransmitted. As duplication of PMF messages may be allowed, the transmitting entity may follow one or more of the following PMF retransmission rules if it determines to retransmit a PMF message.

In an example PMF retransmission rule, if the transmitting entity sent the PMF message initially on an access leg, the transmitting entity may decide to retransmit the PMF message on another (e.g., different) access leg. This rule may be applied to a (e.g., any) steering mode and may be applicable also to the case where duplication may not be enabled or permitted.

In an example PMF retransmission rule, if the transmitting entity sent the PMF message initially on an access leg, the WTRU may decide to retransmit the PMF message on multiple (e.g., two) access legs including the original access leg.

It may be possible for the transmitting entity to send the original PMF message on one access leg and to decide to retransmit the PMF message on an access leg with better-measured performance (e.g., in terms of an PLR and/or an RTT). This rule may be applied to any steering mode, and may also be applied to the case where duplication may be not enabled or permitted.

The transmitting entity may include an indication (e.g., a bit field) in a PMF message (e.g., PMF packet) to indicate that the message may be a retransmission of an original PMF message. An ATSSS layer may use this indication to identify retransmitted PMF messages.

If duplication is enabled for PMF messages, a receiving entity may receive multiple copies of a PMF message (e.g., at 3 of FIG. 6). The receiving entity may rely on an extended procedure transaction identity (EPTI) to help identify duplicate transmissions of PMF messages and discard the duplicate transmissions. In examples (e.g., for PMF ECHO REQUEST signaling), a number of messages may share the same EPTI. For these messages, the receiving entity may determine that a PMF message may be a duplicate if it has the same EPTI and the same request identity (RI) as a prior PMF message.

Additional functionality may be provided for PMF messages related to suspending traffic duplication. For example, if a PMF message transmission has been attempted a maximum number of times, a first network device (e.g., a UPF) may notify another network device (e.g., an SMF) about the number of transmissions so that the SMF may send a control plane message to the WTRU (e.g., at 4 of FIG. 6) indicating that the PFM transmission has failed. In an example, if the UPF has requested that duplication be suspended and the UPF has observed traffic from the WTRU over a suspended access, the UPF may trigger a retransmission of the PMF suspend message without waiting for the expiry of the retransmission timer described herein.

A WTRU and/or a network device (e.g., a UPF) may implement procedures related to an MA-PDU session if traffic duplication is suspended and a mobility event occurs at the WTRU (e.g., the WTRU changes serving cells). As described herein, the suspension of traffic duplication may be a network (e.g., UPF) decision and may or may not be based on WTRU mobility. When traffic duplication is suspended, the WTRU may not send uplink traffic for a service data flow over the suspended access leg, and the uplink traffic (e.g., all of the uplink traffic) associated with the service data flow may go over another access leg, which may be referred to as an active access leg. As a result of WTRU mobility, the WTRU may change its serving cell on the suspended access leg, the active access leg, or in some cases, both the suspended access leg and the active access leg. The WTRU and/or the network device (e.g., the UPF) may perform certain operations to facilitate the WTRU mobility event (e.g., change of serving cells).

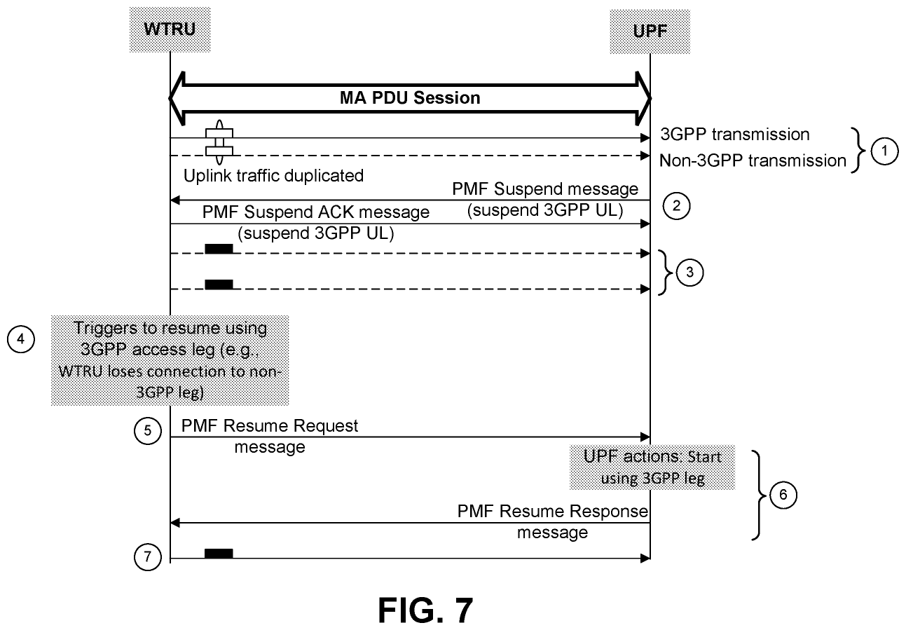

In an example, because of WTRU mobility, the WTRU may lose connectivity on the active access leg (e.g., when the WTRU moves out of coverage). FIG. 7 shows an example of handling WTRU mobility (e.g., wherein the WTRU may have lose connectivity to an access leg) while traffic duplication is suspended. For ease of description, it is assumed in this example that the WTRU has established an MA-PDU session with a redundant steering mode. Further, transmissions over an 3GPP access leg are shown in FIG. 7 as solid lines while transmissions over a non-3GPP access leg are shown as dashed lines in the figure.

At 1 of FIG. 7, the WTRU may send duplicate transmissions over multiple (e.g., two) access legs. At 2 of FIG. 7, a network device (e.g., a UPF) may determine that traffic duplication over a 3GPP access leg may be suspended and the network device may send a suspension request message to the WTRU. At 3 of FIG, 7, the WTRU may perform uplink transmissions (e.g., all uplink transmissions) over the non-3GPP access leg in response to receiving the request message from the network device.

At 4 of FIG, 7, an event at the WTRU may trigger the WTRU to decide to resume traffic duplication. The triggering event may be associated with one or more of the following. The triggering event may be associated with the WTRU losing connection to the access network node of the non-3GPP access leg. The triggering event may be associated with the quality of the non-3GPP access leg falling below a threshold or degrading quickly. The triggering event may be associated with PLR and/or RTT requirements no longer being met over the non-3GPP access leg. The triggering event may be associated with the WTRU starting an SDF that may use duplication. The triggering event may be associated with the WTRU changing its serving cell (e.g., serving access network node over) in the non-3GPP access leg (e.g., changing WiFi access points). The triggering event may be associated with a user requesting traffic duplication through a user interface. In the example in FIG. 7, it may be assumed the WTRU has lost connection to the non-3GPP access leg.

At 5 of FIG. 7, the WTRU may initiate a duplication resume procedure. The WTRU may send a resume request message (e.g., a PMF resume request message) to the network device (e.g., the UPF). This message may be sent over the 3GPP access and include one or more of the following information elements and/or parameters. The resume request message may include a cause value, which may indicate why the message was sent. The cause value may be an Indication of the triggering event. The resume request message may include an indication of the time at which uplink transmission over the suspended access leg may be resumed. For example, the WTRU may request the duplication to be resumed in K msecs. The resume request message may include an indication of a serving cell over the suspended access leg (e.g., the 3GPP leg). While the 3GPP access leg is suspended, the WTRU may have changed its serving cell (e.g., because of cell reselection or handover), and the network device (e.g., the UPF) may use aforementioned indication to re-activate the suspended access leg.

At 6 of FIG. 7, the network may decide to keep the 3GPP access leg suspended, to resume duplication (e.g., over the 3GPP and non-3GPP access leg), or move traffic (e.g., all uplink traffic) to the access leg previously suspended (e.g., to move traffic from the non-3GPP access leg to the 3GPP access leg). The network device may make the decision based on the cause value included in the resume request message. The network device may respond with a resume response message (e.g., a PMF resume response message). The resume response message may include one or more of the following information elements and/or parameters. The resume response message may include an Indication of whether the resume request is rejected or accepted. If the request is accepted, the resume response message may further indicate whether traffic duplication is resumed or whether uplink traffic is only allowed over the access leg previously suspended.

In the example of FIG. 7, the WTRU may be instructed to resume uplink transmission over the 3GPP access leg that was previously suspended. In response, the WTRU may, at 7 of FIG. 7, perform uplink transmissions over the 3GPP leg, as indicated by the resume response message.

In an example, the WTRU may send, at 5 of FIG. 7, the resume request message over the non-3GPP access leg if that access leg is still available after the triggering event at 4. In an example, if the WTRU has no connectivity over the non-3GPP access, the WTRU may send a PDU Session Establishment request or a PDU Session Modification request to the network (e.g., instead of the resume request). This message may have a request type field set to “MA PDU Request” and a PDU Session ID field set to that of the suspended MA-PDU session.

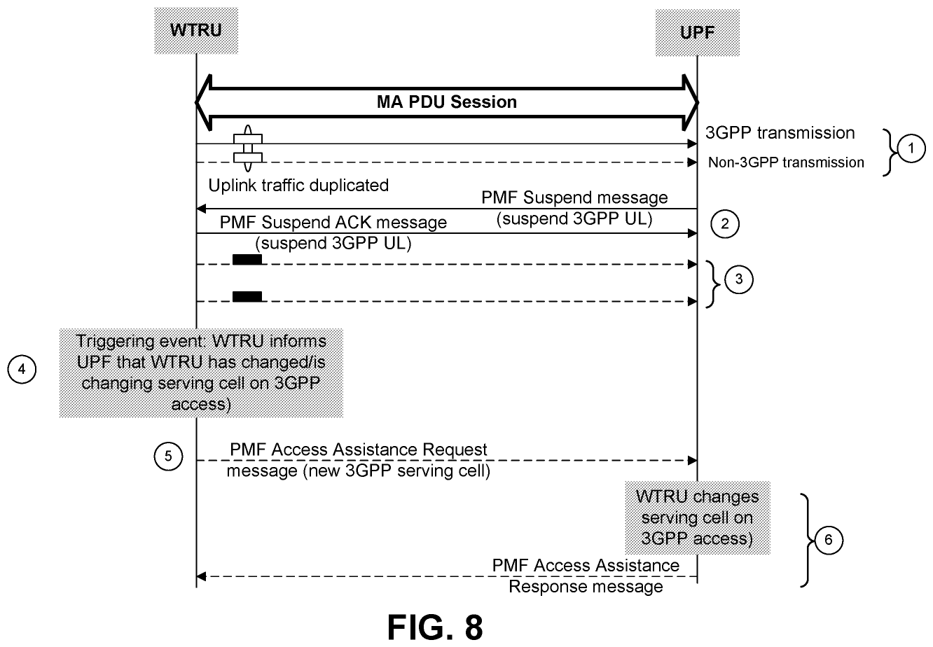

FIG. 8 is a diagram illustrating an example of a WTRU notifying a network if the WTRU changes a serving cell on a suspended access leg. The WTRU may change the serving cell on the suspended access leg due to WTRU mobility, which may occur, for example, when a WTRU undergoes a cell reselection or a cell handover over a 3GPP access leg. In the example of FIG. 8, the WTRU may have established an MA-PDU session in a redundant steering mode. Also, transmissions over the 3GPP access leg are shown as solid lines ion FIG. 8 while transmissions over a non-3GPP access leg are shown as dashed lines in the figure.

At 1 of FIG. 8, the WTRU may send duplicate transmissions over multiple (e.g., two) access legs. At 2 of FIG. 8, a network device (e.g., a UPF) may determine to suspend traffic duplication over the 3GPP access leg and may send a suspension request message to the WTRU. At 3 of FIG. 8, the WTRU may perform uplink transmissions (e.g., all uplink transmissions) over the non-3GPP access leg in response to receiving the request message.

At 4 of FIG. 8, a triggering event may occur at the WTRU, which may prompt the WTRU to inform the network device (e.g., the UPF) about the event and/or take one or more actions. The triggering event may be associated with one or more of the following. The triggering event may be associated with the WTRU losing connection to the 3GPP access leg (e.g., to an access network node of the 3GPP access leg). The triggering event may be associated with the WTRU changing its serving cell to another cell (e.g., due to cell reselection or cell handover). The triggering event may be associated with quality of the 3GPP access leg rising above a threshold. The triggering event may be associated with the WTRU terminating an SDF and no longer wishing to use traffic duplication. The triggering event may be associated with a user requesting, via a user interface, that duplication be terminated.

In the example in FIG. 8, the WTRU may have changed its serving cell and may, at 5, initiate an assistance procedure (e.g., using PMF signaling), The WTRU may send an access assistance request message (e.g., a PMF access assistance request message) to the network device (e.g., the UPF). This message may be sent over the non-3GPP access leg. The message may include a cause value, which may indicate why the message was sent (e.g., the cause value may indicate the triggering event).

At 6 of FIG. 8, the network device (e.g., the UPF) may use the assistance information provided by the WTRU to set up an N3 interface between the network device and the serving cell (e.g., a new serving cell). The network device may respond to the WTRU with an access assistance response message (e.g., a PMF access assistance response message). This message may include an indication that an N3 interface to the new serving cell has been set up.

Although features and elements described above are described in particular combinations, each feature or element may be used alone without the other features and elements of the preferred embodiments or in various combinations with or without other features and elements. Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-20. (canceled)

21. A wireless transmit/receive unit (WTRU), comprising:
a processor configured to:
receive, from a first network node, configuration information regarding suspension of traffic duplication;
receive a request message from a second network node, wherein the request message indicates a request to suspend traffic duplication;
determine, based on the configuration information received from the first network node, the request message received from the second network node, and a condition at the WTRU, to suspend duplicating traffic, at least partially, in a first access leg of the WTRU; and
send a response message to the second network node, wherein the response message indicates that traffic duplication is suspended in the first access leg.

22. The WTRU of claim 21, wherein the condition at the WTRU is associated with at least one of a power consumption of the WTRU, a frequency used by the WTRU, a connection type associated with the first access leg or a second access leg, or a performance metric associated with the first access leg or the second access leg.

23. The WTRU of claim 21, wherein the response message sent to the second network node further indicates a duration or a periodicity of the suspension of traffic duplication in the first access leg.

24. The WTRU of claim 21, wherein the response message sent to the second network node further indicates that the WTRU is to use a second access leg for transmission or reception of traffic while traffic duplication in the first access leg is suspended.

25. The WTRU of claim 21, wherein the processor is further configured to enter a power saving mode in response to receiving the request message from the second network node.

26. The WTRU of claim 21, wherein the request message received from the second network node indicates a duration or a periodicity of the suspension of traffic duplication, an access leg to be used during the suspension of traffic duplication, or a steering mode to be used during the suspension of traffic duplication.

27. The WTRU of claim 21, wherein the request message received from the second network node indicates one or more service data flows (SDFs) exempted from the suspension of traffic duplication, and wherein the processor is further configured to continue duplicating traffic associated with the one or more SDFs in the first access leg.

28. The WTRU of claim 21, wherein the first access leg is associated with one of a cellular communication network or a non-cellular communication network, and wherein, during the suspension of traffic duplication, the processor is further configured to perform transmission or reception of traffic in a second access leg that is associated with the other one of the cellular communication network or the non-cellular communication network.

29. The WTRU of claim 21, wherein the suspension of traffic duplication is associated with a multiple-access protocol data unit session.

30. The WTRU of claim 21, wherein the configuration information is received as a part of access traffic steering, switching and splitting (ATSSS) rules.

31. A method implemented by a wireless transmit/receive unit (WTRU), the method comprising:
receiving, from a first network node, configuration information regarding suspension of traffic duplication;
receiving a request message from a second network node, wherein the request message indicates a request to suspend traffic duplication;
determining, based on the configuration information received from the first network node, the request message received from the second network node, and a condition at the WTRU, to suspend duplicating traffic, at least partially, in a first access leg of the WTRU; and
sending a response message to the second network node, wherein the response message indicates that traffic duplication is suspended in the first access leg.

32. The method of claim 31, wherein the condition at the WTRU is associated with at least one of a power consumption of the WTRU, a frequency used by the WTRU, a connection type associated with the first access leg or a second access leg, or a performance metric associated with the first access leg or the second access leg.

33. The method of claim 31, wherein the response message sent to the second network node further indicates a duration or a periodicity of the suspension of traffic duplication in the first access leg.

34. The method of claim 31, wherein the response message further indicates a second access leg to be used by the WTRU for transmission or reception of traffic while traffic duplication in the first access leg is suspended.

35. The method of claim 31, further comprising entering a power saving mode in response to receiving the request message from the second network node.

36. The method of claim 31, wherein the request message received from the second network node indicates a duration or a periodicity of the suspension of traffic duplication, an access leg to be used during the suspension of traffic duplication, or a steering mode to be used during the suspension of traffic duplication.

37. The method of claim 31, wherein the request message received from the second network node indicates one or more SDFs exempted from the suspension of traffic duplication, and wherein the method further comprises continuing to duplicate traffic associated with the one or more SDFs in the first access leg.

38. The method of claim 31, wherein the first access leg is associated with one of a cellular communication network or a non-cellular communication network, and wherein the method further comprises performing transmission or reception of traffic in a second access leg that is associated with the other one of the cellular communication network or the non-cellular communication network during the suspension of traffic duplication in the first access leg.

39. The method of claim 31, wherein the suspension of traffic duplication is associated with a multiple-access protocol data unit session.

40. The method of claim 31, wherein the configuration information is received as a part of access traffic steering, switching and splitting (ATSSS) rules.
